(19) United States
(12) Patent Application Publication
(10) Pub. No.: US 2002/0176611 A1
(43) Pub. Date: Nov. 28, 2002

(54) Fingerprint addressing system and method

(76) Inventor: Mimi C. Dong, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/863,560

(22) Filed: May 23, 2001

(51) Int. Cl. G06K 9/00

(52) U.S. Cl. 382/124

(57) ABSTRACT

A device includes a connection to a network such as the Internet, and the device has a network address derived from a fingerprint.

### TECHNICAL FIELD OF THE INVENTION

This invention relates to networks in general, and more particularly to fingerprint-based addressing system and method.

### BACKGROUND OF THE INVENTION

The global network or Internet addresses or IP (Internet protocol) addresses are expressed in dotted decimal notation of four fields of eight bits in the form of XXX.XXX.XXX.XXX, where X is any number between 0 and 9, and where each three-digit field has a value between 001 and 256. The IP addresses are commonly expressed as uniform resource locators (URLs) in the form of textual addresses that humans can easily recall and enter. The textual addresses are translated by domain name servers into IP addresses. Although textual addresses allow easy recall, the availability of domain names or URLs that are of a reasonable length is quickly diminishing even as new top level domain extensions and international extensions are issued. It has often been said that it is easier to find an available trademark than an Internet domain name, since the description of goods and services in trademarks allows one trademark to be distinguished over another similar or identical trademark.

### SUMMARY OF THE INVENTION

It may be seen that there is a need for a way to address Internet nodes in a convenient and facilitated way for Internet users and yet avoid the problem of duplicating existing domain names. The present invention is directed to the concept of fingerprint-based addressing—a user may use its fingerprint to specify a predetermined network node without having to enter an address. In the case of the Internet or the World Wide Web, the fingerprint may be used to specify a URL (uniform resource locator). The user's fingerprint may be stored in a file, mobile device, or other storage devices to be used by the user or other authorized users to specify the address.

In accordance with an embodiment of the present invention, a device includes a connection to a network, and a network address derived from a fingerprint.

In accordance with another embodiment of the present invention, a system includes a connection to a network, and a network address derived from a fingerprint of an authorized user.

In accordance with yet another embodiment of the present invention, a method includes the steps of generating a network address derived from a fingerprint, and accessing a system over a network using the derived network address.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block diagram of an embodiment of the fingerprint-based network addressing system according to the teachings of the present invention;

FIG. 2 is a simplified block diagram of a second embodiment of the fingerprint-based network addressing system according to the teachings of the present invention; and

FIG. 3 is a simplified block diagram of yet another embodiment of the fingerprint-based network addressing system according to the teachings of the present invention.

### DETAILED DESCRIPTION OF THE DRAWINGS

The preferred embodiment of the present invention and its advantages are best understood by referring to FIGS. 1 through 3 of the drawings, like numerals being used for like and corresponding parts of the various drawings.

A person's fingerprint(s) can provide a basis for generating one or more unique Internet or routing addresses associated with that person. Addressing can be done by attaching or specifying a file containing a predetermined representation of a fingerprint. Further, a person desiring to access computers or systems associated with his/her fingerprint can specify the address by allowing a fingerprint scanner to procure a fingerprint, which is then processed to generate a network or Internet address. Furthermore, the fingerprint can be used as a basis for gaining access to a secured system. There are various applications of these concepts.

FIG. 1 is a simplified block diagram of an embodiment of a fingerprint-based network addressing system 10 according to the teachings of the present invention. System 10 includes a home or facility-based computer or cluster of computers 12, which may include a server 16 coupling networked appliances 18-21 to the Internet 14. Appliances 18-21 may be computers, processors, workstations, electronic devices, device controllers, other networks, or any device capable of communicating with server 16 over network 22. Appliances 18-21 may also include HVAC (heating, ventilating and air conditioning) systems, lighting systems, home appliances (telephone, washer, dryer, dish washer, refrigerator, freezer), home entertainment components (television, DVD player, VCR, satellite receiver), etc. Network 22 may be any form of network executing any suitable network protocol that is capable of interconnecting server 16 and appliances 18-21 for conveying data and control signals. A mobile controller 24 is coupled to a fingerprint scanner 26 and able to receive data representing a scanned fingerprint therefrom. Mobile controller 24 may be a computer, personal digital assistant (PDA), WAP (wireless application protocol) -enabled telephone, or other suitable devices that is able to communicate with server 16 over the Internet 14. For example, a portable communication device having a fingerprint scanner and identification system described in U.S. Pat. No. 6,141,436 issued to Srey et al. may be used or incorporated into mobile controller 24 for this functionality. The manner in which mobile controller 24 accesses the Internet 14 may be via a wireless modem, satellite transmit/receiver, or any other suitable means. It should be noted that although a mobile devices is shown and discussed herein, the contemplated fingerprint-based IP (Internet protocol) addressing scheme may be used in non-mobile devices such as desktop computers and workstations as well.

A user's fingerprint is used as a basis for formulating and generating a network, or an Internet IP address for server 16 and appliances 18-21. To access server 16 and any appliance 18-21, a user scans his/her fingerprint by using scanner 26. Mobile controller 24 uses the scanned fingerprint and generates an IP address. Methods such as the fingerprint analyzing and encoding system described in U.S. Pat. No. 6,002,787 issued to Takhar et al. provides for converting the raster fingerprint image to vector lines in order to generate a unique value. The unique value can be further manipulated by a known algorithm to generate an IP address. The user then uses the generated IP address to specify the destination server for accessing information on server 16, obtaining the status of appliances 18-21, or sending control data to appliances 18-21. The IP address of appliances 18-21 may be translated from an external Internet address by a process known as NAT (network address translation) to an internal IP subnet address for delivery and routing of data to the specific appliance on network 22.

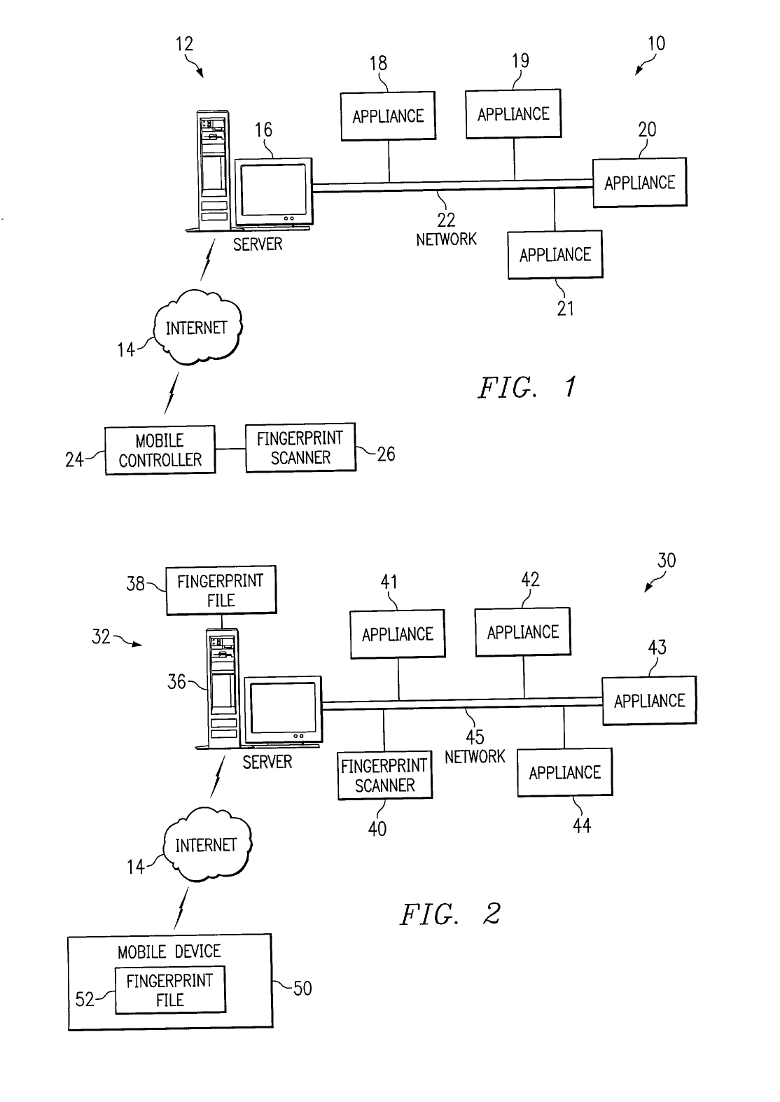

FIG. 2 is a simplified block diagram of a second embodiment of a fingerprint-based network addressing system 30 according to the teachings of the present invention. A system 32 of server 36, fingerprint scanner 40, and appliances 41-44 are interconnected by a network 45. A memory or storage device (not shown) internal or external to server 36 stores a fingerprint file 38. Fingerprint scanner 40 is used to obtain the fingerprints of user(s) who have authorization to access system 32. Fingerprint file 38 contains the procured fingerprint(s) of user(s). The fingerprints may be images, raster scan data, and/or other formats of data representative of scanned fingerprints. The scanned fingerprint images or specific regions of the scanned images may be processed in any suitable way to derive a basis for the generation of an IP address or fingerprint signature. Server 36 further connects appliances 41-44 to the Internet 14 to allow user access via the Internet 14. A mobile device 50 such as laptop computers, notebook computers, PDAs, WAP-enabled telephones, and other suitable wireless devices as well as wireline devices may be used to access server 36. Mobile device 50 includes a fingerprint file 52 that a user may invoke to address server 36 and appliances 41-44. Fingerprint file 52 may also be used to match and confirm that a user, who has just scanned his/her fingerprint, is one of the authorized users.

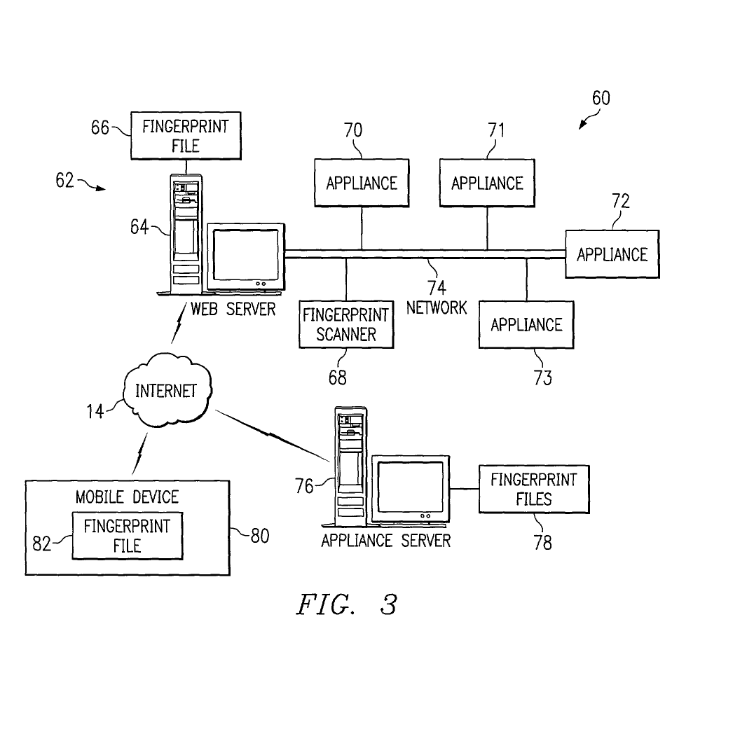

FIG. 3 is a simplified block diagram of yet another embodiment 60 of the fingerprint-based network addressing system according to the teachings of the present invention. A system 62 includes an appliance server 64 which has access to a stored fingerprint file 66. Fingerprint file 66 contains the fingerprints or IP addresses based on the fingerprints. Appliance server 64 is capable of communicating with the Internet 14 and is coupled to appliances 70-73 via a network 74. A fingerprint scanner 68 may also be networked with appliances 70-73 and appliance server 64. A web server 76 containing one or more web pages devoted to the remote control and access of its subscribers' appliances who may be distributed in remote locations. Web server 76 also has access to fingerprint files 78 containing the fingerprints of it's service subscribers or the IP addresses based on the fingerprints.

A user using a mobile device 80 is capable of accessing appliances 70-73 by using his/her stored fingerprint or fingerprint-based IP address or URL in fingerprint file 82. User may submit the fingerprint or fingerprint-based address information to web server 76. Web server 76 may function as a portal and verifies the fingerprint and based on the fingerprint determine the IP address of appliance server 64. The user then may issue commands to turn on/off certain appliances, change the setting of certain appliances, get a status on certain appliances, and perform other activities via the Internet connection.

It may be seen from the foregoing that by using fingerprints as the basis for an IP address or access authorization signature, the uniqueness thereof is guaranteed. Furthermore, because a person always has his/her finger and easy production of a fingerprint, a unique IP address can be specified or entered without reliance on the user's memory. This is especially advantageous for users who are using mobile devices to access remote computers and appliances, who can easily provide a fingerprint without having to type in an address. The fingerprint is used as the basis of an Internet address of a remote system. The user can check on the operation status of a roast cooking in the oven at home, for example, while driving home from work or out running errands. PDAs and other mobile devices may be equipped with a scanner so that a digital fingerprint file may be obtained by laying a finger on the screen, for example. The fingerprint is then used as the basis of an address of the remote system.

What is claimed is:

1. A device comprising:
a connection to a network; and
a network address derived from a fingerprint.

2. The device, as set forth in claim 1, wherein the network is the Internet and network address is an Internet address.

3. The device, as set forth in claim 1, further comprising a fingerprint scanner.

4. The device, as set forth in claim 1, further comprising a fingerprint file storing the fingerprint.

5. The device, as set forth in claim 1, further comprising a fingerprint file storing the network address derived from the fingerprint.

6. A system comprising:
a connection to a network; and
a network address derived from a fingerprint of a dependent user.

7. The system, as set forth in claim 6, wherein the network address is derived from a fingerprint of an authorized user.

8. The system, as set forth in claim 6, wherein the network address is an Internet address.

9. The system, as set forth in claim 6, wherein the network address is an address of a global network.

10. The system, as set forth in claim 6, further comprising a fingerprint scanner.

11. The system, as set forth in claim 6, further comprising a memory storing a fingerprint file having the fingerprint.

12. The system, as set forth in claim 6, further comprising a fingerprint file storing the network address derived from the fingerprint.

13. The system, as set forth in claim 6, further comprising:
a server coupled to the Internet; and
at least one appliance coupled to the server.

14. A method, comprising:
generating a network address derived from a fingerprint; and
accessing a system over a network using the derived network address.

15. The method, as set forth in claim 14, further comprising obtaining a fingerprint.

16. The method, as set forth in claim 14, further comprising storing the fingerprint.

17. The method, as set forth in claim 14, further comprising generating an Internet address of the system derived from the fingerprint.

18. The method, as set forth in claim 14, wherein accessing the system comprises accessing a server coupled to the Internet using the generated network address, and accessing a plurality of appliances coupled to the server using network addresses based on the generated network address.

19. The method, as set forth in claim 14, further comprising generating system authorization based on the fingerprint.
